(19) United States
(12) Patent Application Publication
(10) Pub. No.: US 2014/0117779 A1
(43) Pub. Date: May 1, 2014

(54) ELECTRONIC CONTROL APPARATUS AND METHOD FOR CHECKING RESET FUNCTION

(71) Applicant: Mando Corporation, Pyeongtaek-si (KR)

(72) Inventor: Do Young KIM, Suwon-si (KR)

(73) Assignee: Mando Corporation, Pyeongtaek-si (KR)

(21) Appl. No.: 14/065,709

(22) Filed: Oct. 29, 2013

(30) Foreign Application Priority Data
Oct. 29, 2012 (KR) 10-2012-0120356

(51) Int. Cl. H01H 47/00

(52) U.S. Cl. CPC H01H 47/002
USPC 307/116

(57) ABSTRACT

The present invention relates to an electronic control apparatus, more particularly, to a method of checking a reset function in an electronic control apparatus. The present invention checks whether a sub-controller that monitors a main controller in an electronic control apparatus normally performs the function.

### CROSS-REFERENCE TO RELATED APPLICATION

This application claims priority from and the benefit under 35 U.S.C. §119(a) of Korean Patent Application No 10-2012-0120356, filed on Oct. 29, 2012, which is hereby incorporated by reference for all purposes as if fully set forth herein.

### BACKGROUND OF THE INVENTION

1. Field of the Invention

The present invention relates to an electronic control apparatus, and more particularly to a method of checking a reset function in an electronic control apparatus.

2. Description of the Prior Art

Introduction of an Electric Control Unit (ECU) used in a car has strengthened a function of stability. A currently used Electric Power Steering (EPS) uses a sub-Motor Control Unit (MCU) that senses an abnormal operation of an MCU and resets the MCU when the MCU malfunctions. However, the current EPS does not check a reset function which is a final goal associated with the sub-MCU.

In addition to the EPS, an electronic control apparatus including sub-controller that monitors a main controller and generates a reset signal does not check a reset function which is a final goal of the sub-controller, either.

FIG. 1 is a block diagram of a general electronic control apparatus 10 that monitors a main controller and generates a reset signal.

Referring to FIG. 1, the electronic control apparatus 10 includes a main controller 11 and a sub-controller 12. The sub-controller 12 monitors a state of the main controller 11 through a line 14 that is used for sensing a state and for signal exchange. When the sub-controller 12 determines that the main controller 11 is in a predetermined state (a malfunction state), the sub-controller 12 generates a reset signal through a reset signal line 13 so as to reset the main controller 11.

When the sub-controller 12 performs the reset function normally, the main controller 11 that malfunctions may return to normal state through resetting. However, the sub-controller 12 abnormally performs the reset function, the main controller 11 that malfunctions may not return to the normal state through resetting.

### SUMMARY OF THE INVENTION

Accordingly, the present invention has been made to solve the above-mentioned problems occurring in the prior art, and an object of the present invention is to provide a method of checking whether a reset function of a sub-controller normally operates.

In order to accomplish this object, there is provided an electronic control apparatus for checking a reset function, the electronic control apparatus including: a main controller that outputs a test failure signal, senses a reset signal output from a sub-controller in response to the test failure signal, and checks a reset function of the sub-controller; and the sub-controller that senses the test failure signal, outputs the reset signal, and controls the reset signal not to be output to a reset pin of the main controller.

In accordance with another aspect of the present invention, there is provided a method for an electronic control apparatus to check a reset function, the method to a reset pin of a main controller from a sub-controller; outputting a test failure signal from the main controller to the sub-controller; outputting a reset signal from the sub-controller in response to the test failure signal; and sensing, by the main controller, the reset signal so as to check a reset function of the sub-controller.

According to the present invention as described above, whether a sub-controller normally performs a reset function is checked.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a general electronic control apparatus that monitors a main controller and generates a reset signal;

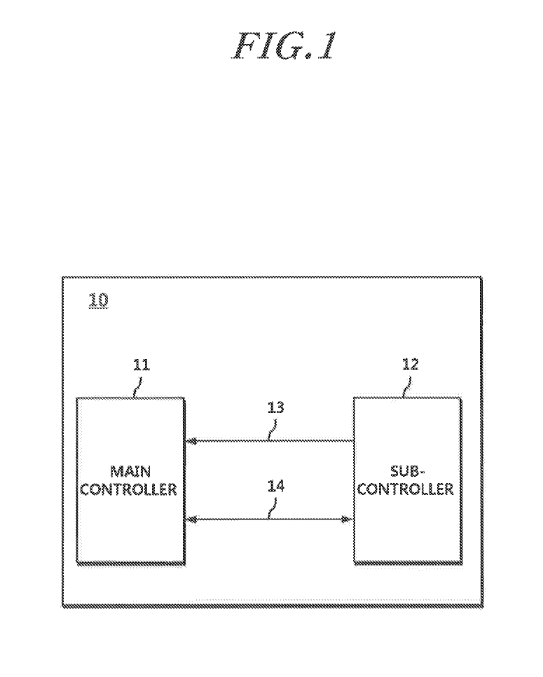

FIG. 2 is a block diagram of an electronic control apparatus according to an embodiment or the present invention;

FIG. 3 is a detailed block diagram of an electronic control apparatus according to an embodiment of the present invention;

FIG. 4 is a circuit diagram illustrating a connection relationship of pins between a main controller and a sub-controller; and

FIG. 5 is flowchart of a method of checking another reset function according to an embodiment of the present invention.

### DETAILED DESCRIPTION OF THE EXEMPLARY EMBODIMENTS

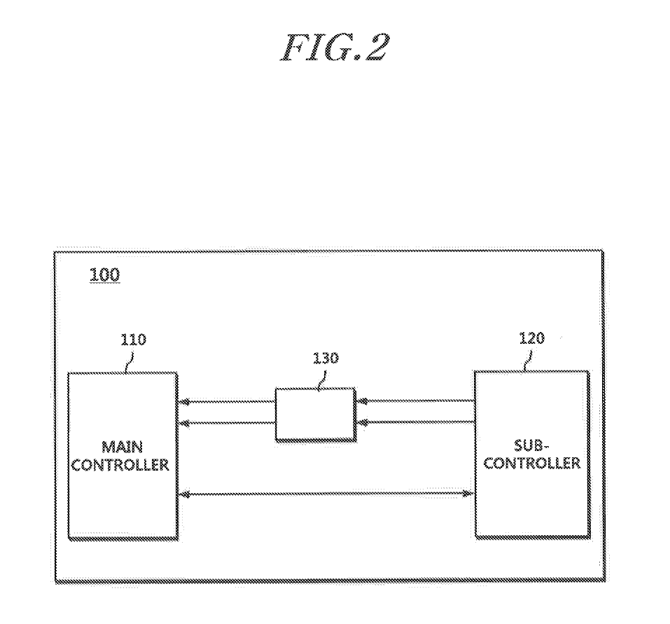

FIG. 2 is a block diagram of an electronic control apparatus 100 according to an embodiment of the present invention.

Referring to FIG. 2, the electronic control apparatus 100 includes a main controller that outputs a test failure signal and checks a reset function of a sub-controller 120 by sensing a reset signal output from the sub-controller 120 in response to the test failure signal, and the sub-controller 120 that outputs a reset signal by sensing the test failure signal and controls the reset signal not to be output to a reset pin of the main controller 110. Also, the electronic control apparatus 100 further includes a switching unit 130, and the switching unit 130 may be omitted.

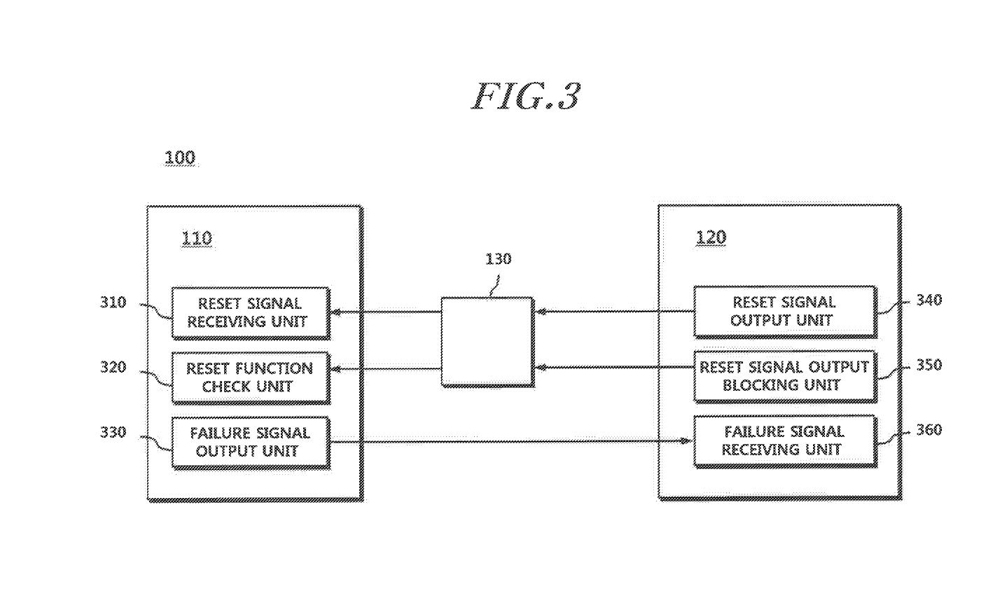

FIG. 3 is a detailed block diagram of the electronic control apparatus 100 according to an embodiment of the present invention.

Referring to FIG. 3, the main controller 110 includes a reset signal receiving unit 310, a reset function check unit 320, a failure signal output unit 330, and the like. The sub-controller 120 includes a reset signal output unit 340, a reset signal output blocking unit 350, a failure signal receiving unit 360, and the like.

The failure signal output unit 30 of the main controller 110 outputs a test failure signal. The test failure signal is one of the signals output when the main controller 110 is in a failure state. The main controller 110 stores, in a data form, one of the signals output when the main controller 110 is in the failure state or stores a signal pattern, and generates a signal using the stored data or the pattern so as to output a test failure signal. The main controller 110 further includes a separate failure signal generator, and controls the failure signal output unit 330 to output a test failure signal using the failure signal generator.

When the failure signal output unit 330 of the main controller 110 outputs a test failure signal, the signal is transferred to the failure signal receiving unit 360 of the sub-controller 120 through a failure signal transceiving line 140. The test failure signal is identical to a normal failure signal that the sub-controller 120 may recognize and thus, when the sub-controller 120 senses a test failure signal that is received through the failure signal receiving unit 360, the sub-controller 120 generates a reset signal.

The generated reset signal is output through the reset signal output unit 340 of the sub-controller 120. The reset signal is a signal that may be transferred to the reset pin of the main controller 110 and may enable resetting to be executed in the main controller 110. Therefore, in a case of a test failure signal, the reset signal is prevented from being transmitted to the reset pin of the main controller 110. The reset signal output blocking unit 350 of the sub-controller 120 controls the reset signal generated by the test failure signal to not be output to the reset pin of the main controller 110.

The reset signal receiving unit 310 of the main controller 110 receives a reset signal from the sub-controller 120 when it is not in a test state that transmits a test failure signal and checks a reset function, so as to enable the main controller 110 to perform resetting. However, the reset signal generated by the test failure signal is not output to the reset pin of the main controller 110 and thus, the reset signal receiving unit 310 does not receive the reset signal.

A reset signal, of which output to the reset pin of the main controller 110 is blocked, is transferred to the reset function check unit 320 of the main controller 110. The reset function check unit 320 senses a reset signal output from the sub-controller 120 in response to a test failure signal, and checks a reset function of the sub-controller 120. The test failure signal is recognized by the sub-controller 120 equivalently in the same manner as a normal failure signal and thus, the sub-controller 120 outputs a reset signal in response to the test failure signal, and the reset function check unit 320 of the main controller 110 senses the reset signal and checks the reset function of the sub-controller 120.

When the sub-controller 120 normally performs the reset function, the sub-controller 120 outputs a normal reset signal with respect to a test failure signal, and the reset function check unit 320 of the main controller 110 senses the reset a signal and determines that the reset function of the sub-controller 120 is normal. Conversely, when the sub-controller 120 malfunctions, and abnormally performs the reset function, the sub-controller 120 may not output a normal reset signal with respect to a test failure signal and the reset function check unit 320 of the main controller 110 senses an abnormal reset signal or fails to sense a normal reset signal from the sub-controller 120 for at least a predetermined period of time and thus, the reset function check unit 320 determines that the reset function of the sub-controller 120 is in a failure state.

Although not illustrated in FIGS. 2 and 3, the reset function check unit 320 of the main controller 110 checks a reset function of the sub-controller 120 and a result of the checking is transmitted to another part (not illustrated) and the other part that receives the reset function checking result may generate an alarm sound or may display an alarm in a screen so that a user may recognize the result. Also, when the electronic control apparatus 100 according to an embodiment of the present invention is mounted on a part of which safety is regarded to be important such as a car, the electronic control apparatus 100 takes an additional safety action by which control is taken away from the main controller 110 which is electronically performed and given to a user, in addition to merely enabling the other part (not illustrated) to display an alarm.

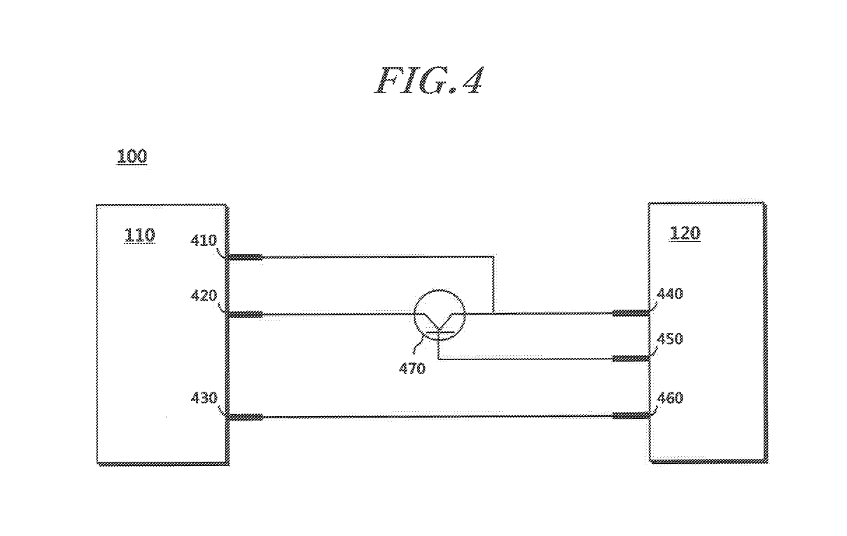

FIG. 4 is a circuit diagram illustrating a connection relationship of pins between the main controller 110 and the sub-controller 120.

Referring to FIG. 4, the main controller 110 includes a reset function check pin 410, a reset pin 420, and a failure signal output pin 430, and the sub-controller 120 includes a reset signal output pin 440, a reset signal output blocking pin 450, and a failure signal receiving pin 460.

Referring continuously to FIG. 4, and referring again to FIG. 3, a state in which each pin is connected to an internal block will be described. In the main controller 110, the reset function check pin 410 provides a path that is connected to the reset function check unit 320, and in which the reset function check unit 320 senses a reset signal of the sub-controller 120. In the main controller 110, the reset pin 420 provides a path that is connected to the reset signal receiving unit 310, and that receives a reset signal from the sub-controller 120. In the main controller 110, the failure signal output pin 430 provides a path that is connected to the failure signal output unit 330 and that outputs a test failure signal to the sub-controller 120.

Referring continuously to FIGS. 3 and 4, a state in which each pin of the sub-controller 120 is connected to an internal block will be described. In the sub-controller 120, the reset signal output pin 440 provides a path that is connected to the reset signal output unit 340, and that outputs a reset signal. In the sub-controller 120, the reset signal output blocking pin 450 provides a path that is connected to the reset signal output blocking unit 350, and that outputs a signal for controlling a reset signal generated in response to a test failure signal not to be output to the reset pin of the main controller 120. The failure signal receiving pin 460 of the sub-controller 120 provides a path that is connected to the failure signal receiving unit 360, and that senses a test failure signal output from the main controller 110.

Referring again to FIG. 4, a state in which a pin of the main controller 110 is connected to a pin of the sub-controller 120 and a switch 470 will be described. Here, the switch 470 is an example of the switching unit 130 of FIGS. 2 and 3, and is configured in a form of a transistor.

The reset pin 420 of the main controller 110 and the reset signal output pin 440 of the sub-controller 120 are connected through the switch 470. While reset function checking is not performed, the switch 470 is in an ON state and thus, the sub-controller 120 senses a failure signal of the main controller 110 and outputs a reset signal through the reset signal output pin 440, and the main controller 110 receives the reset signal through the reset pin 420 and performs resetting.

Conversely, while reset function checking is performed, the switch 470 is in an OFF state. In other words, the sub-controller 120 further includes the switch 470 in the reset signal output pin 440 that outputs a reset signal, and turns off the switch 470 so as to control a reset signal output in response to a test failure signal not to be output to the reset pin 420 of the main controller 110.

In this example, to sense the reset signal which is not output to the reset pin 420 of the main controller 110 since the switch 470 is turned off, the reset function check pin 410 of the main controller 110 is connected between the reset signal output pin 440 of the sub-controller 120 and the switch 470. The main controller 110 senses, between the reset signal output pin 440 and the switch, the reset signal output from the sub-controller 120, and checks a reset function of the sub-controller 120.

The switch 470 is a semi-conductor switch, such as a transistor. Examples of the semi-conductor switch include a transistor, a Field Effect Transistor (FET), and the like. The semi-conductor switch turns on and off a switch by inputting a control signal to a switch on/off control signal input unit such as a base (for a transistor) or a gate (for an FET). When the switch 470 is a transistor, the sub-controller 120 connects the reset signal output blocking pin 450 to a base of the transistor, and outputs a signal to the reset signal output blocking pin 450 so as to turn off the transistor.

The failure signal output pin 430 of the main controller 110 provides a path that is connected to the failure signal receiving pin 460 of the sub-controller 120, and in which a test failure signal output from the main controller 110 is transferred to the sub-controller 120.

Although it is described that the sub-controller 120 performs a function of controlling a reset signal output in response to a test failure signal not to be output to the reset pin 420 of the main controller 110, this is merely an embodiment of the present invention. A function of changing an output path so that a reset signal is not output to the reset pin 420 of the main controller 110 is performed by the main controller 110. For example, a reset signal output blocking block (not illustrated) such as the reset signal output blocking unit 350 that outputs an on/off control signal to the switch 470 of FIG. 4 may be included in the main controller 110. The reset signal output blocking block (not illustrated) may turn on and off the switch 470 by inputting a control signal to the on/off control signal input unit of the switch 470 (for example, a base or a gate). Accordingly, the reset signal output from the sub-controller 120 may be output to the reset pin 420, or may be output to the reset function check pin 410.

The electronic control apparatus 100 that checks the reset function according to an embodiment of the present invention has been described. Hereinafter, a method for the electronic control apparatus 100 to check a reset function according to an embodiment of the present invention will be described. The method of checking a reset function according to an embodiment of the present invention may be performed by the electronic control apparatus 100 as illustrated in FIG. 2 according to an embodiment of the present invention.

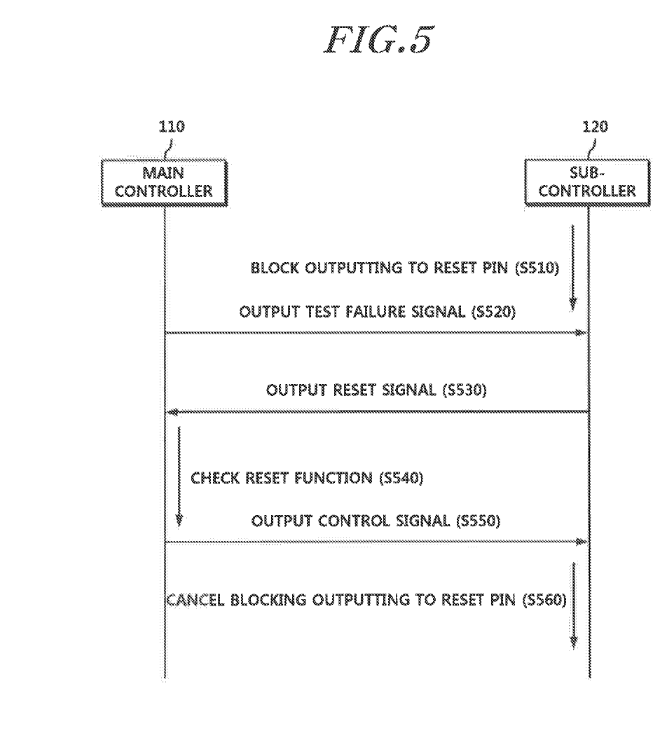

FIG. 5 is a flowchart illustrating a method of checking a reset function according to an embodiment of the present invention.

Referring to FIG. 5, the main controller 110 of the electronic control apparatus 100 and the sub-controller 120 receive or transmit a signal, and each performs a predetermined step, so that the method in which the electronic control apparatus 100 checks a reset function is performed.

The sub-controller 120 blocks outputting a reset signal to the reset pin 420 of the main controller 110 in step S510. This is to prevent the main controller 110 from being reset by the reset signal generated in response to a test failure signal in a process in which the electronic control apparatus 100 checks a reset function of the sub-controller 120.

In step S510 that blocks outputting the reset signal to the reset pin 420, the sub-controller 120 further includes a switch in the reset signal output pin 440 that outputs a reset signal, and turns off a switch so as to block outputting the reset signal to the reset pin 420 of the main controller 110.

The main controller 110 outputs a test failure signal to the sub-controller 120 in step S520. The test failure signal is one of the signals output when the main controller 110 is in a failure state. The main controller 110 stores, in a form of data, one of the signals output when the main controller 110 is in a failure state or stores a signal pattern, and generates a signal using the stored data or pattern so as to output a test failure signal. The main controller 110 further includes a failure signal generator, and outputs a test failure signal using the failure signal generator.

The sub-controller 120 generates a reset signal based on the test failure signal output from the main controller 110. The generated reset signal is output to the main controller 110 in step S530.

The main controller 110 senses the reset signal output from the sub-controller 120, and checks a reset function of the sub-controller in step S540. When the sub-controller 120 further includes a switch in the reset signal output pin 440 that outputs the reset signal, the main controller 110 senses, between the reset signal output pin 440 and the switch, the reset signal output from the sub-controller 120, and checks the reset function of the sub-controller 120.

When the sub-controller 120 normally performs a reset function, the sub-controller 120 outputs a normal reset signal with respect to the test failure signal, and the main controller 110 senses the reset signal and determines that the reset function of the sub-controller 120 is normal. Conversely, when the sub-controller 120 malfunctions, and abnormally performs the reset function, the sub-controller 120 does not output a normal reset signal with respect to the test failure signal and the main controller 110 senses an abnormal reset signal or fails to sense a normal reset signal from the sub-controller 120 during at least a predetermined period of time. Therefore, the main controller 110 determines that the reset function of the sub-controller 120 is in a failure state.

After the main controller 110 checks the reset function in step S540, the main controller 110 outputs a control signal to the sub-controller 120 in step S550, and the sub-controller 120 cancels blocking so that the reset signal is output to the reset pin 420 of the main controller 110 based on the control signal in step S560. The additional steps S550 and S560 show that the main controller 110 terminates checking the reset function of the sub-controller 120, and changes a mode into a normal operation mode.

What is claimed is:

1. An electronic control apparatus for checking a reset function, the electronic control apparatus comprising:
a main controller that outputs a test failure signal, senses a reset signal output from a sub-controller in response to the test failure signal, and checks a reset function of the sub-controller; and
the sub-controller that senses the test failure signal, outputs the reset signal, and controls the reset signal not to be output to a reset pin of the main controller.

2. The electronic control apparatus of claim 1, wherein the sub-controller further includes a switch in a reset signal output pin that outputs the reset signal, and turns off the switch so as to control the reset signal output in response to the test failure signal not to be output to the reset pin of the main controller.

3. The electronic control apparatus of claim 2, wherein the main controller senses, between the reset signal output pin and the switch, the reset signal output from the sub-controller so as to check a reset function of the sub-controller.

4. The electronic control apparatus of claim 2, wherein the switch is a transistor, and the sub-controller connects a reset signal output blocking pin to a base of the transistor and outputs a signal to the reset signal output blocking pin so as to turn off the transistor.

5. A method for an electronic control apparatus to check a reset function, the method comprising the steps of:
blocking outputting a reset signal to a reset pin of a main controller from a sub-controller;
outputting a test failure signal from the main controller to the sub-controller;
outputting a reset signal from the sub-controller in response to the test failure signal; and
sensing, by the main controller, the reset signal so as to check a reset function of the sub-controller.

6. The method of claim 5, wherein the sub-controller further includes a switch in a reset signal output pin that outputs the reset signal; and
blocking outputting the reset signal comprises;
turning off the switch so as to block outputting the reset signal to the reset pin of the main controller.

7. The method of claim 6, wherein checking the resent function comprises:
sensing, by the main controller between the reset signal output pin and the switch, the reset signal output from the sub-controller so as to check the reset function of the sub-controller.

8. The method of claim 5, wherein, after checking the reset function, the method further comprises:
outputting a control signal to the sub-controller from the main controller, and cancelling blocking so that the sub-controller outputs a reset signal to the reset pin of the main controller based on the control signal.
